(19) United States
(12) Patent Application Publication
(10) Pub. No.: US 2014/0337504 A1
(43) Pub. Date: Nov. 13, 2014

(54) DETECTING AND MANAGING SLEEPING COMPUTING DEVICES

(71) Applicant: MICROSOFT CORPORATION, Redmond, WA (US)

(72) Inventors: Jacob R. Lorch, Bellevue, WA (US); Jitu Padhye, Redmond, WA (US); Wei Wan, Redmond, WA (US); Eric Zager, Seattle, WA (US); Brian Zill, Bellevue, WA (US)

(73) Assignee: Microsoft Corporation, Redmond, WA (US)

(21) Appl. No.: 13/889,350

(22) Filed: May 8, 2013

(51) Int. Cl. H04L 12/26

(52) U.S. Cl. CPC H04L 43/0805
USPC 709/224

(57) ABSTRACT

A method, system, and one or more computer-readable storage media for detecting sleeping computing devices are provided herein. The method includes querying, via a computing device, a system neighbor table of the computing device to determine whether a target computing device is reachable and, if the target computing device is unreachable, sending a neighbor discovery packet to the target computing device. The method also includes re-querying the system neighbor table to determine whether the target computing device is reachable and, if the target computing device is unreachable, determining whether the target computing device has been determined to be unreachable at least a specified number of times in a row. The method further includes determining that the target computing device is manageable if the target computing device has been determined to be unreachable at least the specified number of times in a row.

### BACKGROUND

Collectively, computing devices in enterprise environments use a lot of energy by remaining on when idle. By putting these computing devices to sleep, large enterprises can achieve significant cost savings. In cloud service environments, for example, some threshold number of servers may be kept awake to provide cloud services. While some servers may be permitted to sleep, their availability is maintained in case of increased demand for services. In desktop environments, many operating systems put a desktop computer to sleep after some amount of user idle time, but users and IT administrators typically override this to enable remote access. Remote access is typically used to remotely access files or other resources on the desktop computer. IT administrators may use remote access to access other desktop computers to perform maintenance tasks. Thus, any system for putting computing devices to sleep also attempts to maintain their availability for remote access.

There are a number of techniques for managing sleeping computing devices to achieve power savings while maintaining the availability of the sleeping computing devices. Managing a sleeping computing device may include, but is not limited to, inspecting traffic for the computing device, answering simple requests on behalf of the computing device, and awakening the computing device in response to a valid service request for the computing device. However, many of the techniques are challenging to implement. Some techniques use specialized hardware, while others use a fully virtualized desktop, or application stubs, which implicate further technological challenges. Moreover, such techniques rely on the initial determination of which computing devices are asleep, since only sleeping computing devices are to be managed. According to current techniques for detecting sleeping computing devices, periodic probes, such as pings, are sent to a computing device. If no response is received from the computing device or its manager, the computing device is considered to be manageable. However, such techniques suffer from various flaws that can arise under certain network conditions. For instance, if pings are blocked in a network, then probes consisting of pings will not reach the computing devices. Therefore, according to current techniques, it may be difficult to detect which computing devices are manageable.

### SUMMARY

The following presents a simplified summary of the present embodiments in order to provide a basic understanding of some aspects described herein. This summary is not an extensive overview of the claimed subject matter. It is intended to neither identify critical elements of the claimed subject matter nor delineate the scope of the present embodiments. Its sole purpose is to present some concepts of the claimed subject matter in a simplified form as a prelude to the more detailed description that is presented later.

An embodiment provides a method for detecting a sleeping computing device. The method includes querying, via a computing device, a system neighbor table of the computing device to determine whether a target computing device is reachable and, if the target computing device is unreachable, sending a neighbor discovery packet to the target computing device. The method also includes re-querying the system neighbor table to determine whether the target computing device is reachable and, if the target computing device is unreachable, determining whether the target computing device has been determined to be unreachable at least a specified number of times in a row. The method further includes determining that the target computing device is manageable if the target computing device has been determined to be unreachable at least the specified number of times in a row.

Another embodiment provides a computing device for detecting a sleeping computing device. The computing device operates within a subnetwork including a number of computing devices. The computing device includes a processor and a system memory. The system memory includes code configured to direct the processor to query a local system neighbor table to determine whether a target computing device operating within the subnetwork is reachable and, if the target computing device is unreachable, send a neighbor discovery packet to the target computing device. The system memory also includes code configured to direct the processor to re-query the local system neighbor table to determine whether the target computing device is reachable and, if the target computing device is unreachable, determine whether the target computing device has been determined to be unreachable at least a specified number of times in a row. The system memory further includes code configured to direct the processor to determine that the target computing device is manageable and manage the target computing device if the target computing device has been determined to be unreachable at least the specified number of times in a row.

In addition, another embodiment provides one or more computer-readable storage media for storing computer-readable instructions. The computer-readable instructions provide for the detection of a sleeping computing device when executed by one or more processing devices. The computer-readable instructions include code configured to query a local system neighbor table to determine whether a target computing device is reachable and, if the target computing device is unreachable, send a neighbor discovery packet to the target computing device. The computer-readable instructions also include code configured to re-query the system neighbor table to determine whether the target computing device is reachable and, if the target computing device is unreachable, determine whether the target computing device has been determined to be unreachable at least a specified number of times in a row. The computer-readable instructions further include code configured to determine that the target computing device is manageable if the target computing device has been determined to be unreachable at least the specified number of times in a row.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a block diagram of a system for detecting and managing sleeping computing devices;

FIG. 2 is a block diagram of a computing environment that may be used to implement a system and method for detecting and managing sleeping computing devices;

FIG. 3 is a generalized process flow diagram of a method for detecting a sleeping computing device that is to be managed; and

FIG. 4 is a process flow diagram of a method for determining whether a target computing device is manageable.

### DETAILED DESCRIPTION

As discussed above, techniques for managing sleeping computing devices rely on the initial determination of which computing devices are actually asleep, since only sleeping computing devices are to be managed. Current techniques for detecting sleeping computing devices use a traditional probing mechanism that involves sending pings to computing devices that are suspected of being asleep. However, if pings are disabled on a computing device, the traditional probing mechanism may determine that the computing device is asleep regardless of whether computing device is awake or sleep. Therefore, the computing device may be managed even if it is awake. Furthermore, if the address resolution protocol (ARP) offload disablement is broken on a network interface card (NIC) of a computing device, the computing device may be considered to be manageable. Therefore, the computing device may be managed by both the NIC itself and a separate manager. This may cause flapping of the route in the networking hardware.

Accordingly, embodiments described herein provide for the detection of sleeping computing devices using a testing mechanism that involves sending neighbor discovery (ND) requests (or ARP requests) to computing devices that are suspected of being asleep. This approach is reliable because neighbor discovery is a fundamental aspect of any network. Therefore, in contrast to the pings used according to the traditional probing mechanism, the ND/ARP requests used according to the testing mechanism described herein will not be blocked in any network. Furthermore, in contrast to the traditional probing mechanism, the testing mechanism described herein will determine that a sleeping computing device should not be managed if the NIC of the sleeping computing device is still actively maintaining its own presence on the network.

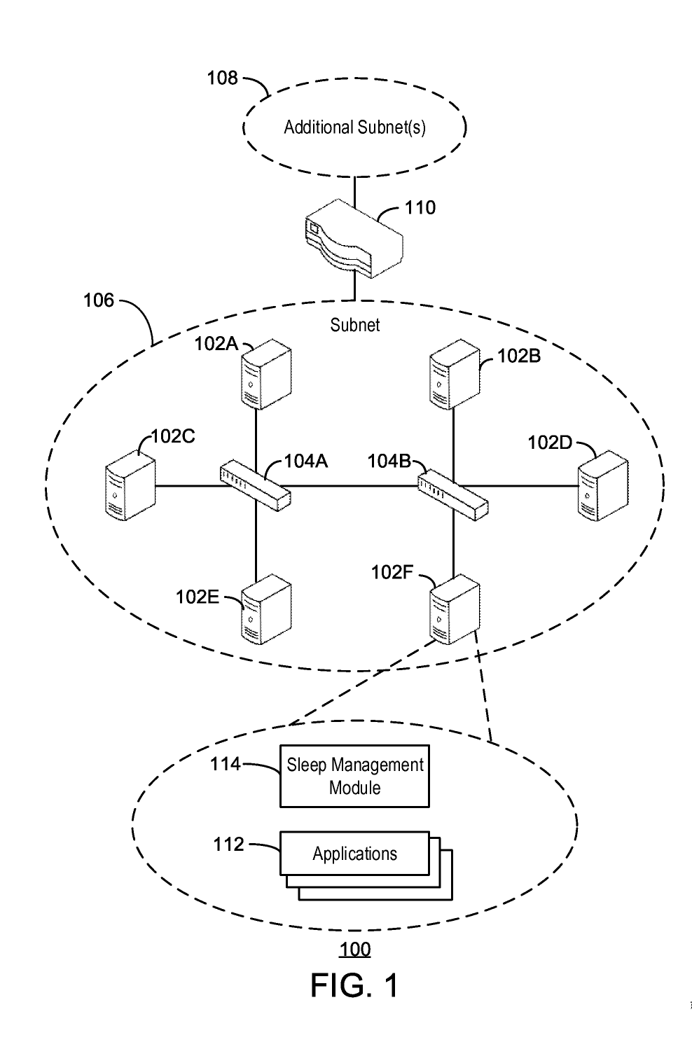

As a preliminary matter, some of the figures describe concepts in the context of one or more structural components, variously referred to as functionality, modules, features, elements, or the like. The various components shown in the figures can be implemented in any manner, such as via software, hardware, e.g., discrete logic components, or firmware, or any combinations thereof. In some embodiments, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1, discussed below, provides details regarding one system that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, manual processing, or the like. As used herein, hardware may include computer systems, discrete logic components, application specific integrated circuits (ASICs), or the like.

As to terminology, the phrases “configured to” and “adapted to” encompass any way that any kind of functionality can be constructed to perform an identified operation. The functionality can be configured to (or adapted to) perform an operation using, for instance, software, hardware, firmware, or the like.

The term “logic” encompasses any functionality for performing a task. For instance, each operation illustrated in the flowcharts corresponds to logic for performing that operation. An operation can be performed using, for instance, software, hardware, firmware, or the like.

As used herein, the terms “component,” “system,” “server,” and the like are intended to refer to a computer-related entity, either hardware, software, e.g., in execution, or firmware, or any combination thereof. For example, a component can be a process running on a processor, an object, an executable, a program, a function, a library, a subroutine, a computer, or a combination of software and hardware.

By way of illustration, both an application running on a server and the server can be a component. One or more components can reside within a process, and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable storage device or media.

Computer-readable storage media can include but are not limited to magnetic storage devices, e.g., hard disk, floppy disk, and magnetic strips, among others, optical disks, e.g., compact disk (CD) and digital versatile disk (DVD), among others, smart cards, and flash memory devices, e.g., card, stick, and key drive, among others. In contrast, computer-readable media, i.e., not storage media, generally may additionally include communication media such as transmission media for wireless signals and the like.

FIG. 1 is a block diagram of a system 100 for detecting and managing sleeping computing devices. The system 100 includes a logical grouping of multiple nodes 102A, 102B, 102C, 102D, 102E, and 102F interconnected by one or more switches 104A and 104B, which route traffic to the individual nodes 102A-F. The logical grouping of nodes 102A-F may include a subnetwork (or “subnet”) 106, although other implementations may employ the described techniques in other logical groupings. In one embodiment, the nodes 102A-F of the subnet 106 may provide a service, e.g., a cloud service.

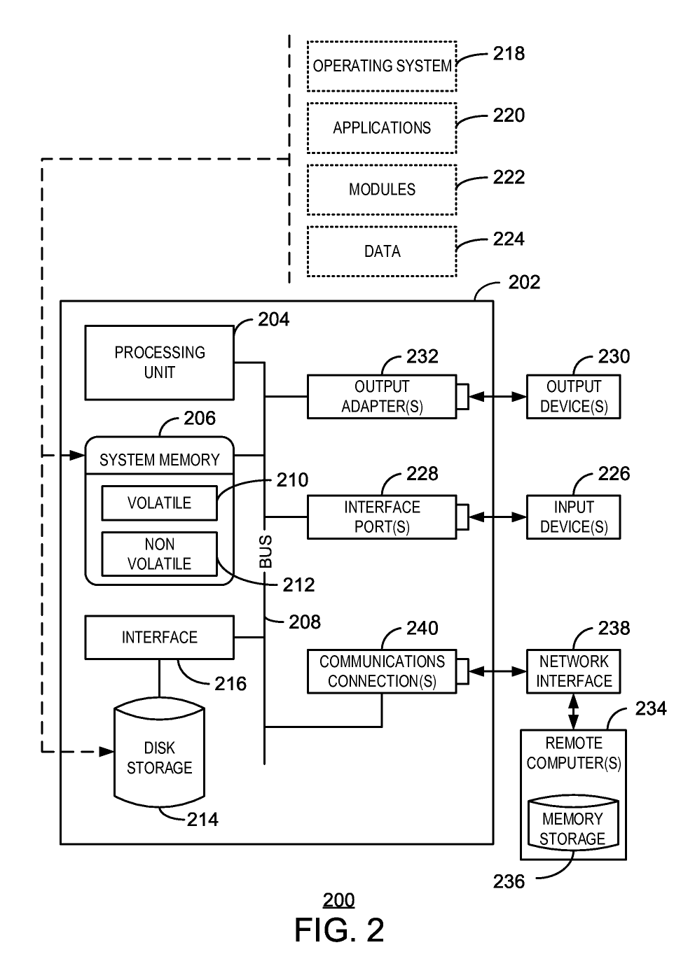

As used herein, the term “node” refers to a computing device that operates within the subnet 106. While FIG. 1 illustrates the nodes 102A-F uniformly, these nodes 102A-F may include any combination of desktop computers, laptop computers, servers, or other suitable computing devices. Moreover, in some embodiments, one or more of the nodes 102A-F includes the computer described below with respect to the computing environment 200 of FIG. 2.

In various embodiments, the subnet 106 is coupled to one or more additional subnets 108 via a router 110. While a single router 110 is shown, the subnet 106 may be coupled to multiple routers in other implementations.

Each node 102A-F may include one or more applications 112 and a sleep management module 114. The applications 112 may include applications or services available for use by computing devices within and outside of the subnet 106. For example, the applications 112 may support a cloud service provided by the nodes 102A-F in the subnet 106.

As referred to herein, nodes 102A-F that are sleeping may be in a sleep state, hibernate state, or any other state in which another node 102A-F may cause the sleeping node to enter a fully-usable state, such as the S0 power state. In one embodiment, the nodes 102A-F may include inactivity timers that put the nodes 102A-F to sleep.

The nodes 102A-F within the subnet 106 may include, but are not limited to, proxy nodes and manager nodes. A proxy node is a node that is capable of managing one or more sleeping nodes. A manager node is a proxy node that is currently managing one or more sleeping nodes.

The sleep management module 114 enables the system 100 to maintain at least a specified threshold of awake nodes within the subnet 106. In addition, according to embodiments described herein, the sleep management module 114 allows for the determination of which nodes are asleep and, thus, are to be managed at any point in time. Specifically, the sleep management module 114 may enable one or more proxy nodes to test the manageability of one or more other nodes that are suspected of being asleep and unmanaged. According to embodiments described herein, it does so by sending unicast ND/ARP requests. Such a testing mechanism is highly reliable because, no matter what firewall rules are in place within the subnet 106, no installation in any valid configuration would ever disable ND/ARP responses since that would disrupt basic connectivity.

Furthermore, such a testing mechanism may prevent a computing device from being concurrently managed by more than one entity, e.g., by a separate computing device and the NIC of the computing device itself. Specifically, if ARP offload is enabled on the computing device, the NIC of the computing device will respond to the ND/ARP request and, thus, prevent management of the computing device.

In various embodiments, if a potentially-sleeping node does not respond to an ND/ARD request received from a proxy node, the node may be determined to be asleep and, thus, may be managed by the manager node. However, if the potentially-sleeping node does respond to the ND/ARP request by sending an ND/ARP response, the node may be determined to be awake and, thus, may be considered to be unmanageable. As used herein, the term “unmanageable” is used to denote a computing device for which management is currently not appropriate.

In various embodiments, it may be desirable to detect ND/ARP responses without having to continuously run the kernel packet filter. Therefore, the sleep management module 114 may enable a proxy node to query its local system neighbor table, i.e., ARP cache, for information about potentially-sleeping nodes.

In some cases, the proxy node's ARP cache reveals the reachability of other nodes simply by virtue of past traffic sent to the nodes. Therefore, the proxy node may be able to determine which nodes are to be managed without sending any packets whatsoever.

More specifically, because the operating system of the proxy node will automatically detect ND/ARP responses and update the ARP cache appropriately, the operating system application programming interface (API) may be used to read the ARP cache to determine information about potentially-sleeping nodes. For example, the last-recorded state and last-reached time, i.e., the time at which reachability was last observed, for a potentially-sleeping node may be determined from the ARP cache. The test may fail if the state of the potentially-sleeping node is “unreachable,” or if the last-reached time is above a specified threshold. If enough consecutive tests fail in this way, it may be determined that (a) the node is asleep or disconnected; (b) the node is unmanaged; and (c) the node does not have ARP offload enabled. Therefore, the node may be managed by the proxy node.

Alternatively, if the ARP cache reveals that the state of the potentially-sleeping node is “reachable” and that the last-reached time is below a specified threshold, e.g., thirty seconds, the test may be determined to be successful without ever sending any network traffic to the potentially-sleeping node. Therefore, the node may be determined to be unmanageable without the proxy node explicitly generating and sending a unicast ND/ARP request.

In various embodiments, if a node does not have basic network connectivity, it will incorrectly determine that all the nodes in the subnet are manageable. This may cause the node to unnecessarily manage a large number of other nodes. Moreover, if the node is reconnected to the network, the node may disrupt the connectivity of the other nodes. Therefore, according to embodiments described herein, nodes that do not have basic network connectivity are prevented from managing any other nodes within the subnet 106. This may be accomplished by using the operating system API of a node to read the node's ARP cache. In this manner, the reachability of the subnet 106 can be determined without sending any network traffic.

In some embodiments, a hybrid of the testing mechanism described herein and a traditional probing mechanism may be used to determine sleeping nodes. Specifically, the testing mechanism described herein may only be used as a final confirmation that a node is asleep and, thus, is manageable. In other words, a traditional mechanism, such as ping, may be used for the initial determination of potentially-sleeping nodes, and the testing mechanism described herein may only be used after several probes have failed. Using ND/ARP requests as a final confirmation that a node is manageable may ensure that nodes with ARP offload enabled or probe traffic blocked by firewall rules are not accidentally managed. Furthermore, the use of such a hybrid approach may reduce the load on the system hardware by reducing the amount of ND/ARP requests and responses that have to be processed by the system 100.

According to embodiments described herein, once the sleeping nodes within the subnet 106 have been detected, one or more manager nodes may manage the sleeping nodes by inspecting traffic for, and answering simple requests on behalf of, the sleeping nodes. The manager nodes may also awaken the sleeping nodes in response to valid service requests for the sleeping nodes. For example, a manager node may awaken a sleeping node when a TCP SYN arrives for the sleeping node on a port the sleeping node was listening on while awake.

FIG. 2 is a block diagram of a computing environment 200 that may be used to implement a system and method for detecting and managing sleeping computing devices. The computing environment 200 includes a computer 202. In various embodiments, the computer 202 is one of the nodes 102A-F described above with respect to the system 100 of FIG. 1. The computer 202 includes a processing unit 204, a system memory 206, and a system bus 208. The system bus 208 couples system components including, but not limited to, the system memory 206 to the processing unit 204. The processing unit 204 can be any of various available processors. Dual microprocessors and other multiprocessor architectures also can be employed as the processing unit 204.

The system bus 208 can be any of several types of bus structures, including the memory bus or memory controller, a peripheral bus or external bus, or a local bus using any variety of available bus architectures known to those of ordinary skill in the art. The system memory 206 is computer-readable storage media that includes volatile memory 210 and non-volatile memory 212. The basic input/output system (BIOS), containing the basic routines to transfer information between elements within the computer 202, such as during start-up, is stored in non-volatile memory 212. By way of illustration, and not limitation, non-volatile memory 212 can include read-only memory (ROM), programmable ROM (PROM), electrically-programmable ROM (EPROM), electrically-erasable programmable ROM (EEPROM), or flash memory.

Volatile memory 210 includes random access memory (RAM), which acts as external cache memory. By way of illustration and not limitation, RAM is available in many forms, such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 202 also includes other computer-readable storage media, such as removable/non-removable, volatile/non-volatile computer storage media. FIG. 2 shows, for example, a disk storage 214. Disk storage 214 may include, but is not limited to, a magnetic disk drive, tape drive, LS-100 drive, flash memory card, or memory stick. In addition, disk storage 214 can include storage media separately or in combination with other storage media including, but not limited to, an optical disk drive such as a compact disk ROM device (CD-ROM), CD recordable drive (CD-R Drive), CD rewritable drive (CD-RW Drive), or a digital versatile disk ROM drive (DVD-ROM). To facilitate connection of the disk storage 214 to the system bus 208, a removable or non-removable interface is typically used, such as interface 216.

It is to be appreciated that FIG. 2 describes software that acts as an intermediary between users and the basic computer resources described in the computing environment 200. Such software includes an operating system 218. The operating system 218, which can be stored on disk storage 214, acts to control and allocate resources of the computer 202.

System applications 220 take advantage of the management of resources by the operating system 218 through program modules 222 and program data 224 stored either in system memory 206 or on disk storage 214. It is to be appreciated that the claimed subject matter can be implemented with various operating systems or combinations of operating systems.

A user enters commands or information into the computer 202 through input device(s) 226. Input device(s) 226 can include, but are not limited to, a pointing device (such as a mouse, trackball, stylus, or the like), a keyboard, a microphone, a gesture or touch input device, a voice input device, a joystick, a game controller, a satellite dish, a scanner, a TV tuner card, a digital camera, a digital video camera, a web camera, or the like. The input device(s) 226 connect to the processing unit 204 through the system bus 208 via interface port(s) 228. Interface port(s) 228 can include, for example, a serial port, a parallel port, a game port, and a universal serial bus (USB). Output device(s) 230 may also use the same types of ports as input device(s) 226. Thus, for example, a USB port may be used to provide input to the computer 202 and to output information from the computer 202 to an output device 230.

Output adapter(s) 232 are provided to illustrate that there are some output devices 230 like monitors, speakers, and printers, among other output devices 230, which are accessible via the output adapter(s) 232. The output adapter(s) 232 include, by way of illustration and not limitation, video and sound cards that provide a means of connection between the output device 230 and the system bus 208. It can be noted that other devices and/or systems of devices provide both input and output capabilities, such as remote computer(s) 234.

The computer 202 may be a server within a networking environment that includes logical connections to one or more remote computers, such as remote computer(s) 234. For example, as discussed above, the computer 202 may be one of the nodes 102A-F within the subnet 106 described with respect to the system 100 of FIG. 1, and the remote computers 234 may be the other nodes 102A-F within the system 100. The remote computer(s) 234 can include personal computers (PCs), servers, routers, network PCs, mobile phones, peer devices or other common network nodes and the like, and typically include many or all of the elements described relative to the computer 202. For purposes of brevity, the remote computer(s) 234 are illustrated with a memory storage device 236. The remote computer(s) 234 are logically connected to the computer 202 through a network interface 238, and physically connected to the computer 202 via communication connection(s) 240.

Network interface 238 encompasses wired and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 240 refers to the hardware and/or software employed to connect the network interface 238 to the system bus 208. While communication connection(s) 240 is shown for illustrative clarity inside the computer 202, it can also be external to the computer 202. The hardware and/or software for connection to the network interface 238 may include, for example, internal and external technologies such as mobile phone switches, modems including regular telephone grade modems, cable modems and DSL modems, ISDN adapters, and Ethernet cards.

An exemplary embodiment of the computer 202 may include a server providing cloud services. The server may be configured to provide a sleep management service as described herein. An exemplary processing unit 204 for the server may be a computing cluster comprising Intel® Xeon CPUs. The disk storage 214 may include an enterprise data storage system, for example, holding thousands of impressions. Exemplary embodiments of the subject innovation may automatically determine servers to use for managing other servers.

The block diagram of FIG. 2 merely represents one embodiment of a computing environment that may be used to implement the system and method for detecting and managing sleeping computing devices described herein. Those of skill in the art will appreciate that the subject innovation may be practiced with other computer system configurations. For example, the subject innovation may be practiced with single-processor or multi-processor computer systems, minicomputers, mainframe computers, personal computers, hand-held computing devices, microprocessor-based or programmable consumer electronics, or the like, each of which may operatively communicate with one or more associated devices. The illustrated aspects of the claimed subject matter may also be practiced in distributed computing environments wherein certain tasks are performed by remote processing devices that are linked through a communications network. However, some, if not all, aspects of the subject innovation may be practiced on stand-alone computers. In a distributed computing environment, program modules may be located in local or remote memory storage devices.

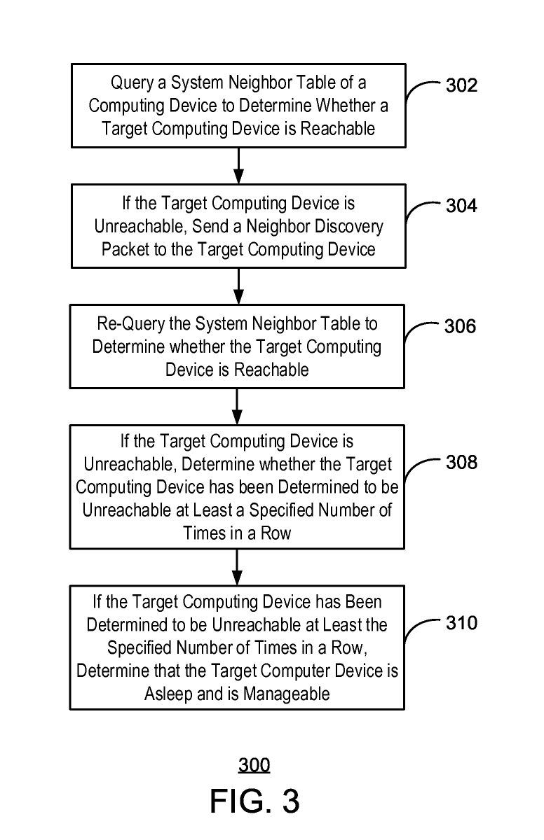

FIG. 3 is a generalized process flow diagram of a method 300 for detecting a sleeping computing device that is to be managed. The method 300 may be implemented by a computing device that operates within a subnetwork that includes a number of computing devices, including at least one target computing device that is suspected of being asleep. The method 300 begins at block 302, at which a system neighbor table of the computing device is queried to determine whether the target computing device is reachable. According to embodiments described herein, the system neighbor table is a local ARP cache of the computing device that is executing the method 300. In various embodiments, the target computing device may be determined to be reachable if the last-reached time for the target computing device recorded in the system neighbor table is less than a specified threshold. Alternatively, the target computing device may be determined to be unreachable if the last-reached time for the target computing device is greater than the specified threshold.

If the target computing device is unreachable, a neighbor discovery packet is sent to the target computing device at block 304. According to embodiments described herein, the neighbor discovery packet is an ND/ARP request that is sent from the computing device that is executing the method 300 to the target computing device. In various embodiments, a specified amount of time is allowed to elapse after the sending of the neighbor discovery packet to allow the target computing device to send an ND/ARP response to the ND/ARP request. The method 300 then proceeds to block 306.

At block 306, the system neighbor table is re-queried to determine whether the target computing device is reachable. Specifically, the system neighbor table may be queried to determine whether the target computing device responded to the neighbor discovery packet. If the target computing device did not respond to the neighbor discovery packet, and if the last-reached time for the target computing device is greater than the specified threshold, the target computing device may be determined to still be unreachable.

If the target computing device is unreachable, the method 300 proceeds to block 308, at which it is determined whether the target computing device has been determined to be unreachable at least a specified number of times in a row. If the target computing has not been determined to be unreachable at least the specified number of times in a row, the method 300 is executed again beginning at block 302. Alternatively, if the target computing device has been determined to be unreachable at least the specified number of times in a row, the target computing device is determined to be asleep and manageable, as shown at block 310. Furthermore, in response to determining that the target computing device is manageable, the computing device may begin managing the target computing device. Managing the target computing device may include inspecting traffic for the target computing device, answering simple requests on behalf of the target computing device, and awakening the target computing device in response to a valid service request for the target computing device.

The process flow diagram of FIG. 3 is not intended to indicate that the blocks of the method 300 are to be executed in any particular order, or that all of the blocks are to be included in every case. Further, any number of additional blocks not shown in FIG. 3 may be included within the method 300, depending on the details of the specific implementation. For example, in some embodiments, the target computing device is probed to determine whether the target computing device is reachable prior to execution of the method 300. Probing the target computing device may include pinging the target computing device and determining that the target computing device is unreachable if it does not respond to the ping. If the target computing device is determined to be unreachable based on the probing, the method 300 may be executed beginning at block 302. Otherwise, the target computing device may be determined to be unmanageable.

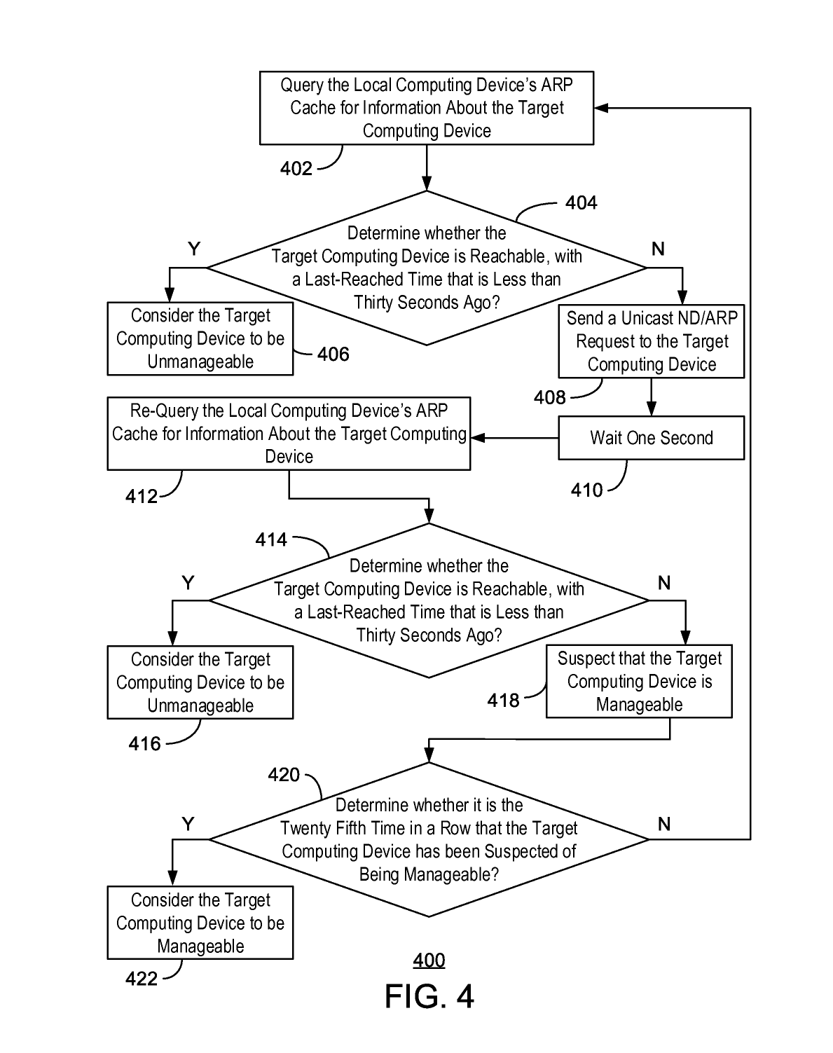

FIG. 4 is a process flow diagram of a method 400 for determining whether a target computing device is manageable. More specifically, a computing device may execute the method 400 to determine whether a target computing device that is suspected of being asleep and unmanaged is indeed manageable by the computing device. In various embodiments, the method 400 represents one embodiment of the method 300 for detecting sleeping computing devices described with respect to FIG. 3.

The method 400 begins at block 402, at which the local computing device's ARP cache is queried for information about the target computing device. At block 404, it is determined whether the target computing device is reachable, with a last-reached time that is less than thirty seconds ago. If the target computing device is reachable and the last-reached time is less than thirty seconds ago, the computing device is considered to be unmanageable at block 406, and the method 400 is terminated. Otherwise, if the target computing device is unreachable and the last-reached time that is more than thirty seconds ago, a unicast ND/ARP request is sent to the target computing device at block 408.

The computing device then waits one second, as shown at block 410, to allow the target computing device time to respond to the ND/ARP request. After one second, the local computing device's ARP cache is re-queried for information about the target computing device at block 412. At block 414, it is determined whether the target computing device is reachable, with a last-reached time that is less than thirty seconds ago. If the target computing device is reachable and the last-reached time is less than thirty seconds, the computing device is considered to be unmanageable at block 416, and the method 400 is terminated. Otherwise, if the target computing device is unreachable and the last-reached time is more than thirty seconds ago, the target computing device is suspected of being manageable, as shown at block 418.

If the target computing device is suspected of being manageable, the method 400 proceeds to block 420, at which it is determined whether it is the twenty-fifth time in a row that the target computing device has been suspected of being manageable. If it is the twenty-fifth time in a row that the target computing device has been suspected of being manageable, the target computing device is considered to be manageable at block 422, and the method 400 is terminated. In various embodiments, the computing device then begins managing the target computing device, as described above with respect to FIGS. 1 and 3. Otherwise, if it is not the twenty-fifth time in a row that the target computing device has been suspected of being manageable, the method is executed again beginning at block 402.

The process flow diagram of FIG. 4 is not intended to indicate that the blocks 402-422 of the method 400 are to be executed in any particular order, or that all of the blocks are to be included in every case. Moreover, any number of additional blocks not shown in FIG. 4 may be included within the method 400, depending on the details of the specific implementation. Further, the process flow diagram of FIG. 4 is not intended to indicate that the particular details of the blocks 402-422 of the method 400 are limited to those shown in FIG. 4. Rather, the particular details of each block 402-422 of the method 400 may be tailored to the specific implementation. For example, the threshold for the last-reached time used at blocks 404 and 414 may be more or less than thirty seconds. In addition, the computing device may wait more or less than one second at block 408, and the number of times that the target computing device has to be suspected of being manageable at block 420 may be more or less than twenty-five times.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for detecting a sleeping computing device, comprising:
querying, via a computing device, a system neighbor table of the computing device to determine whether a target computing device is reachable;
if the target computing device is unreachable, sending a neighbor discovery packet to the target computing device;
re-querying the system neighbor table to determine whether the target computing device is reachable;
if the target computing device is unreachable, determining whether the target computing device has been determined to be unreachable at least a specified number of times in a row; and
if the target computing device has been determined to be unreachable at least the specified number of times in a row, determining that the target computing device is manageable.

2. The method of claim 1, comprising managing the target computing device if the target computing device is manageable.

3. The method of claim 2, wherein managing the target computing device comprises:
inspecting traffic for the target computing device;
answering simple requests on behalf of the target computing device; and
awakening the target computing device in response to a valid service request for the target computing device.

4. The method of claim 1, comprising determining that the target computing device is unmanageable if the target computing device is reachable.

5. The method of claim 1, comprising, if the target computing device has not been determined to be unreachable at least the specified number of times in a row:
re-querying the system neighbor table of the computing device to determine whether the target computing device is reachable;
if the target computing device is unreachable, sending a second neighbor discovery packet to the target computing device;
re-querying the system neighbor table to determine whether the target computing device is reachable;
if the target computing device is unreachable, determining whether the target computing device has been determined to be unreachable at least a specified number of times in a row; and
if the target computing device has been determined to be unreachable at least the specified number of times in a row, determining that the target computing device is manageable.

6. The method of claim 1, comprising determining that the target computing device is reachable if a last-reached time for the target computing device recorded in the system neighbor table is less than a specified threshold.

7. The method of claim 1, comprising:
probing the target computing device to determine whether the target computing device is reachable prior to querying the system neighbor table of the computing device; and
if the target computing device is determined to be unreachable based on the probing, querying the system neighbor table of the computing device to determine whether the target computing device is reachable.

8. The method of claim 7, wherein probing the target computing device to determine whether the target computing device is reachable comprises:
pinging the target computing device; and
if the target computing device does not respond, determining that the target computing device is unreachable.

9. The method of claim 1, comprising querying the local system neighbor table of the computing device to determine whether a subnetwork is reachable.

10. A computing device for detecting a sleeping computing device, wherein the computing device operates within a subnetwork comprising a plurality of computing devices, and wherein the computing device comprises:
a processor; and
a system memory, wherein the system memory comprises code configured to direct the processor to:
query a local system neighbor table to determine whether a target computing device operating within the subnetwork is reachable;
if the target computing device is unreachable, send a neighbor discovery packet to the target computing device;
re-query the local system neighbor table to determine whether the target computing device is reachable;
if the target computing device is unreachable, determine whether the target computing device has been determined to be unreachable at least a specified number of times in a row; and
if the target computing device has been determined to be unreachable at least the specified number of times in a row:
determine that the target computing device is manageable; and
manage the target computing device.

11. The computing device of claim 10, wherein the system memory comprises code configured to direct the processor to determine that the target computing device is unmanageable if the target computing device is reachable.

12. The computing device of claim 10, wherein the system memory comprises code configured to direct the processor to, if the target computing device has not been determined to be unreachable at least the specified number of times in a row:
re-query the local system neighbor table to determine whether the target computing device is reachable;
if the target computing device is unreachable, send a second neighbor discovery packet to the target computing device;
re-query the local system neighbor table to determine whether the target computing device is reachable;
if the target computing device is unreachable, determine whether the target computing device has been determined to be unreachable at least a specified number of times in a row; and
if the target computing device has been determined to be unreachable at least the specified number of times in a row:
determine that the target computing device is manageable; and
manage the target computing device.

13. The computing device of claim 10, wherein the system memory comprises code configured to direct the processor to determine that the target computing device is reachable if a last-reached time for the target computing device recorded in the local system neighbor table is less than a specified threshold.

14. The computing device of claim 10, wherein the system memory comprises code configured to direct the processor to:
probe the target computing device to determine whether the target computing device is reachable prior to querying the local system neighbor table of the computing device; and
if the target computing device is determined to be unreachable based on the probing, query the local system neighbor table of the computing device to determine whether the target computing device is reachable.

15. The computing device of claim 10, wherein the system memory comprises code configured to direct the processor to manage the target computing device by:
inspecting traffic on the subnetwork for the target computing device;
answering simple requests on behalf of the target computing device; and
awakening the target computing device in response to a valid service request for the target computing device.

16. The computing device of claim 10, wherein the system memory comprises code configured to direct the processor to manage a plurality of target computing devices operating on the subnetwork that have been determined to be manageable.

17. The computing device of claim 10, wherein the system memory comprises code configured to direct the processor to query the local system neighbor table of the computing device to determine whether the subnetwork is reachable.

18. One or more computer-readable storage media for storing computer-readable instructions, the computer-readable instructions providing for the detection of a sleeping computing device when executed by one or more processing devices, the computer-readable instructions comprising code configured to:
query a local system neighbor table to determine whether a target computing device is reachable;
if the target computing device is unreachable, send a neighbor discovery packet to the target computing device;
re-query the system neighbor table to determine whether the target computing device is reachable;
if the target computing device is unreachable, determine whether the target computing device has been determined to be unreachable at least a specified number of times in a row; and
if the target computing device has been determined to be unreachable at least the specified number of times in a row, determine that the target computing device is manageable.

19. The one or more computer-readable storage media of claim 18, wherein the computer-readable instructions comprise code configured to determine that the target computing device is unmanageable if the target computing device is reachable.

20. The one or more computer-readable storage media of claim 18, wherein the computer-readable instructions comprise code configured to, if the target computing device has not been determined to be unreachable at least the specified number of times in a row:
re-query the local system neighbor table to determine whether the target computing device is reachable;
if the target computing device is unreachable, send a second neighbor discovery packet to the target computing device;
re-query the local system neighbor table to determine whether the target computing device is reachable;
if the target computing device is unreachable, determine whether the target computing device has been determined to be unreachable at least a specified number of times in a row; and
if the target computing device has been determined to be unreachable at least the specified number of times in a row, determine that the target computing device is manageable.
